(19) United States
(12) Patent Application Publication
(10) Pub. No.: US 2008/0107052 A1
(43) Pub. Date: May 8, 2008

(54) Client mobility in a wireless network

(75) Inventors: Ramanagopal Vogety, Milpitas, CA (US); Mukesh Gupta, Milpitas, CA (US)

Correspondence Address: Tropos Networks Patent Dept, PO Box 641867, San Jose, CA, 95164-1867, US

(73) Assignee: Tropos Networks, Inc.

(21) Appl. No.: 11/594,491

(22) Filed: Nov. 8, 2006

(51) Int. Cl. H04B 7/00

(52) U.S. Cl. 370/310

(57) ABSTRACT

An apparatus and method of a router within a wireless network providing mobility of a client device is disclosed. The method includes defining a routing table of the router, wherein the routing table provides next hop information towards the client device. Entries to the routing table are created, wherein the entries include a client device age that indicates when the client device associated with the wireless network.

### FIELD OF THE INVENTION

The invention relates generally to wireless communications. More particularly, the invention relates to a method and apparatus for providing client mobility in a wireless network.

### BACKGROUND OF THE INVENTION

Wireless mesh networks are gaining popularity because wireless infrastructures are typically easier and less expensive to deploy than wired networks. The wireless mesh networks typically include wired gateways that are wirelessly connected to wireless nodes, or wirelessly connected directly to client devices. Many wireless nodes can collectively provide a wireless mesh, in which client devices can associate with any of the wireless nodes.

Routing paths can be selected between the nodes of the mesh network according to one or more of many possible routing selection procedures. The routing paths provide a path for data flow between a client device associated with the wireless mesh network and a gateway of the mesh network. The gateway can be wire-connected to a wired network which is connected, for example, to the internet. Due to the possibility of changing locations of the wireless nodes, and due to the typically changing link qualities of wireless connections, the best quality routing path available can vary with time. Additionally, wireless clients typically roam from one wireless node to another wireless node.

It is desirable to have a method and apparatus for operating a wireless network that can accommodate for client devices and wireless nodes that roam within the wireless network.

### SUMMARY OF THE INVENTION

One embodiment of the invention includes a method of router within a wireless network providing mobility of a client device. The method includes defining a routing table of the router, wherein the routing table provides next hop information towards the client device. Entries to the routing table are created, wherein the entries include a client device age that indicates when the client device associated with the wireless network. The entries can further include a router device age that indicates when a downstream node most recently selected the router as an upstream device, and an age at next hop that indicates when a next wireless hop router most recently updated its routing table.

Another embodiment includes a method of a wireless mesh network providing client device roaming. The wireless mesh network includes a plurality of access nodes, and the method includes each access node maintaining a routing table. The routing table includes entries that include addresses of all nodes and client devices that route through the access node. Each access node creates entries in the routing table that include a client device age that indicates when a client device associated with the wireless mesh network, and a router device age that indicates when a node within the route, selected the route through the access node.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a wireless network that includes node and client device aging, and a client device roaming.

FIG. 2 shows another wireless network that includes node, client device and next hop aging.

FIG. 3 shows another wireless network that includes roaming of a node.

FIG. 4 is a flow chart that shows steps of maintaining routing tables of a wireless network.

FIG. 5 shows a client device roaming within a wireless mesh network.

FIG. 6 shows an access node roaming within a wireless mesh network.

FIG. 7 shows an access node and a client device roaming within a wireless mesh network.

### DETAILED DESCRIPTION

As shown in the drawings for purposes of illustration, the invention is embodied in an apparatus and method of a wireless network that accommodates for nodes and client devices of the wireless network that roam within the wireless network.

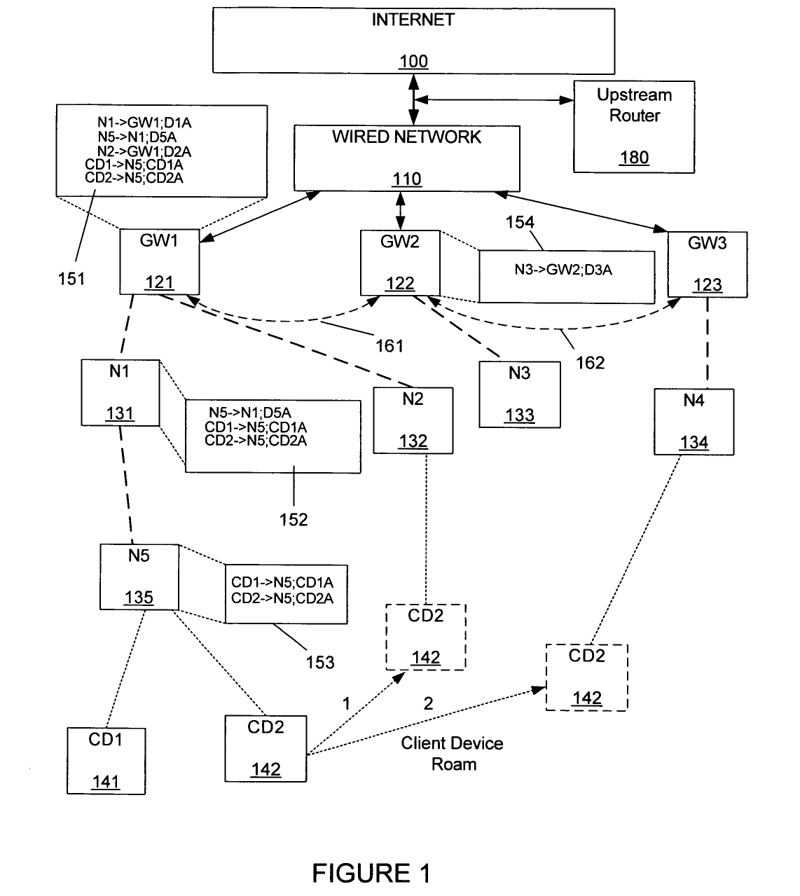

FIG. 1 shows a wireless network that includes gateways 121, 122, 123, wireless access nodes 131, 132, 133, 134, 135 and client devices 141, 142. The gateways 121, 122, 123 and the access nodes 131, 132, 133, 134, 135 together form a wireless mesh that the client devices 141, 142 can associate with, obtaining wireless access to the mesh network, and therefore, access to the wired network 110, and the internet 100. The following description includes wireless mesh networks, but it is to be understood that the embodiments described can be used within wireless networks that contain only wireless access points, and therefore, are not truly wireless mesh networks.

The gateways 121, 122, 123 are typically connected to the wired network 110 through a high-bandwidth connection that can be a wired or wireless connection. The access nodes 131, 132, 133, 134, 135 are generally wirelessly connected forming a wireless mesh network. The wireless connections can vary, and are determined by a routing selection protocol.

The access nodes are typically routers. However, the access nodes can include other types of devices as well.

One routing protocol includes each of the gateways 121, 122, 123 originating routing beacons at a predetermined rate. The access nodes (generally referred to as first-level access nodes) receive the routing beacons and select the gateway that provides the best quality link based on a persistence of routing beacons received. The selected gateway becomes a default gateway. The gateways then re-broadcast the routing beacons that were received, after modifying the routing beacons with additional information. The additional information can include, for example, the address of the access node and/or a hop-count indicator (hop-count indicates the number of wireless hops the access node is from a routing beacon originating gateway). The next access nodes (generally referred to as second-level access nodes) receive the re-broadcast routing beacons, and select an upstream access node that provides the best quality link based on a persistence of the re-broadcast routing beacons received.

The selected routing paths are conveyed to all upstream devices. Upstream devices are either the default gateway, or an access node in a routing path to the default gateway. The selected routing paths are stored within each device so that each device knows how to route data to and from client devices.

Routing Tables

An embodiment includes each device (gateways and access nodes) storing a routing table that includes all devices (access nodes and client devices) that routing through the device. For example, in FIG. 1, a routing table 151 is stored within the gateway 121. The first entry of the routing table 151 shows that the first access node 131 routes through the first gateway 121. The second entry shows that the fifth access node 135 routes through the first access node 131. The third entry shows that the second access node 132 routes through the first gateway 121. The fourth entry shows the first client device 141 is associated with fifth access node 135. The fifth entry shows that the second client device 142 is also associated with the fifth access node 135. The order of the entries as shown and described is purely arbitrary, and is for purposes of illustration only.

The first access node 131 includes a routing table 152 that includes entries containing routing information that depicts the fifth access node 135 routes through the first access node 131, and that the first and second client devices 141, 142 are associated with the fifth access node 135.

The fifth access node 135 includes a routing table 153 that includes entries containing routing information that depicts the first and second client devices 141, 142 are associated with the fifth access node 135.

The routing tables provide each device with the information required to route data to and from the client devices. The client devices 141, 142 communicate with devices connected to the wired network 110, or connected to the internet through the corresponding gateway and intermediate access nodes. The routing tables allow the gateways and access nodes to properly route the data traffic.

The node of the wireless network that has a client device attached can be referred to as a leaf node with respect to the client device. For example, the fifth node 135 has client devices 141, 142 attached to it. Therefore, the fifth node 135 is a leaf node. An embodiment includes the fifth node 135 sending a route update to its upstream node (the first node 131) once every predetermined amount of time (for example, once every one second). The leaf node (fifth node) 135 also transmits a client detection probe (such as, ARP (address resolution protocol)) to the client devices 141, 142 every period of time (such as, once every three seconds) to check if the client device(s) are still attached to it. If the client device is still attached a link to the client device is included within a route update to an upstream device by the leaf node.

The gateways 121, 122, 123 communicate the client device ages, devices ages and age at next hop (described later) to each other. This communication can be in the form of wireless broadcast links 161, 162, or this communication can occur through the wired network 110.

GARPS

An upstream router 180 receives GARPS (Gratuitous Address Resolution Protocol) from the gateways 121, 122, 123 so that the upstream router 180 knows how to route data traffic through the gateways, to the corresponding client devices. For example, the first gateway 121 sends a GARP to the upstream gateway 180 when the first gateway 121 receives a route update for the first client device 141 so that the upstream router 180 routes data traffic to the first client device 141 through the first gateway 121.

Client Device Roaming

The information within the routing tables can become inaccurate when the client devices roam from one node to another node (access node or gateway) within the wireless network. For example, FIG. 1 shows two client device roaming scenarios. The first scenario (designated 1) includes the second client device 142 roaming to the second access node 132. The second scenario (designated 2) includes the second client device 142 roaming to the fourth access node 134. Note that the first roaming scenario includes a new access node, but the same gateway (the first gateway 121). The second roaming scenario includes a new access node and a new gateway (the third gateway 123).

When a client device roams from one access node to another, the routing tables are updated to reflect that the new routing path between the client device and the new (could be the same) gateway.

Client Device Aging

As shown in FIG. 1, the routing tables 151, 152, 153 can additionally include a client device age. The client device age indicates how long or how recently a client device has been associated with a node of the wireless network. An upstream device that receives a route update having a more recent client age, updates its routing table with the route having the more recent client age. The client device ages are shown, for example, in FIG. 1. The first client device 141 age is depicted in the routing tables 151, 152, 153 as CD1A. The second client device 142 age is depicted in the routing tables 151, 152, 153 as CD2A.

Routing Table updates Based on Client Age

The ages of the client devices can be used to maintain the entries of the routing tables. For example, if the client device 142 roams from the fifth access node 135 to the second access node 132, the routing tables of the first gateway 121 and the second access node 132 need to be updated. That is, for example, the first gateway 121 updates its routing table to reflect that the client device 142 is associated with the second access node 132 because the client device age CD2A of the second access node 132 is more recent than the client device age CD1A provided by the first access node 131.

The second access node 132 also updates its routing table to reflect that the client device (CD2) 142 is associated with the second access node 132, and the routing table of the second access node 132 includes an age (CD2A) of the second client device 142. The fifth access node 135 eventually figures out due to a lack of responses from the client device 142 that the client device 142 is no longer associated with the fifth access node 135. The fifth access node 135 then updates its routing table as well.

The routing tables are generally updated with the most recent client device age. However, as will be described, certain other aging parameters can over-ride the client device age. For example, an age at next hop can in some situations over-ride the client device age.

Router Device Aging

In addition to client device ages, access node can also provide a router device age that reflects when the access node associated with the upstream device. The age of a device (access node) is determined by when the access node (router) selected the present route to a gateway. For example, the routing tables 151, 152, 153 depict a router device age for the fifth access node 135 as D5A. Again, the router device age is determined by when, for example, the fifth access node 135 selected its present routing path to the first gateway 121. The routing table tables depict a router device age of the first access node 131 as D1A, and the router device age of the second access node 132 as D2A.

Routing Table updates Based on Router Device Age

The ages of the router devices (access nodes) can be used to maintain the entries of the routing tables. For example, if the fifth access node 135 roams from the first access node 131 to the second access node 132, the routing tables of the first gateway 121 and the second access node 132 need to be updated. That is, for example, the first gateway 121 updates its routing table to reflect that the fifth access node 135 routes through the second access node 132 because the router device age D5A of the second access node 132 is more recent than the router device age D5A provided by the first access node 131.

The second access node 132 also updates its routing table to reflect that the fifth access node 135 routes through the second access node 132, and the routing table of the second access node 132 includes a router device age (D5A) of the fifth access node 135. The first access node 131 eventually figures out due to a lack of routing updates from the fifth access node 135 that the fifth access node 135 is no longer routing through the first access node 131.

Age at Next Hop

The age at next hop depicts the time since a route was installed or updated on the next wireless hop. However, this does not apply to a leaf node. Generally, a next hop router is a device that is one wireless hop downstream from the present device.

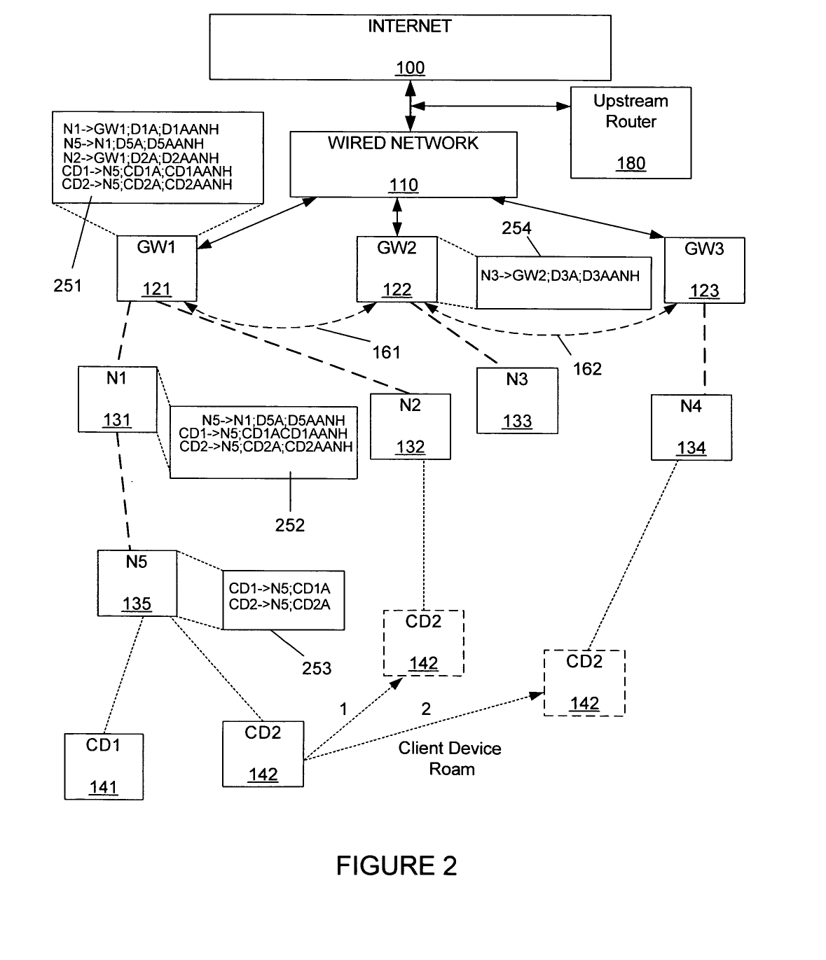

FIG. 2 shows another wireless network that includes node (router device), client device and next hop aging. A routing table 251 of the first gateway 121 includes an age at next hop D1AANH for the first access node 131 that indicates when the first gateway 121 most recently updated its routing table. The routing table 251 also includes an age at next hop D5AANH for the fifth access node 135, an age at next hop D2AANH for the second access node 132, an age at next hop CD1AANH for the first client device 141, and an age at next hop CD2AANH for the second client device 142. The routing table 252 of the first access node includes an age at next hop D5ANH for the fifth access node 135 that indicates when the fifth access node 135 most recently updated its routing table, an age at next hop CD1AANH for the first client device 141, and an age at next hop CD2AANH for the second client device 142. As will be described, the age at next hop for entries within the routing tables can also be used for properly maintaining the entries of the routing table.

Updating Routing Tables Based on Age at Next Hop

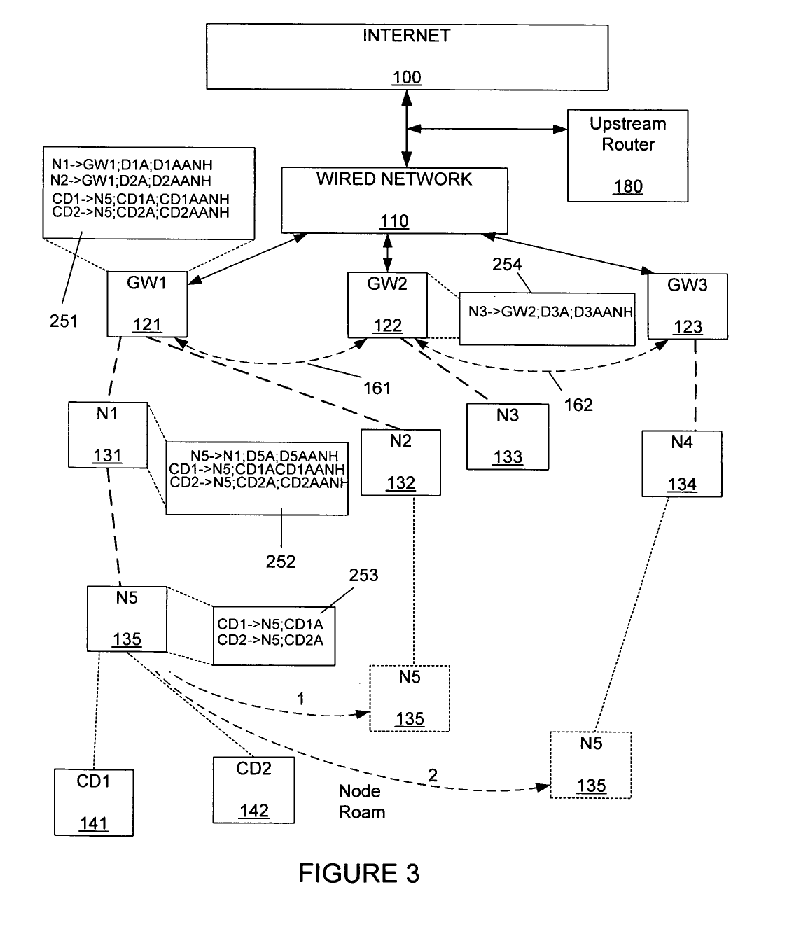

Generally, each gateway and access node updates its routing table with the most recent age at next hop. FIG. 3 shows another wireless network that depicts a node of the wireless network roaming. More specifically, the fifth access node 135 roaming, for example, to either the second access node 132 (designated 1) or to the fourth access node 134 (designated 2). The previously mentioned age at next hop is useful in maintaining routing of traffic when access nodes roam.

When the fifth access node 135 roams from the first access node 131 to the second access node 132, the routing table of the second access node 132 is updated to include the fifth access node 135, along with the device age D2A (reflecting when the fifth access node 135 selected the route with the second access node 132 as its upstream device). Due to the update of the routing table of the second access node 132, the routing table of the first gateway is updated with the new route of the fifth access node 135, but also the age at next hop of the second access node 132. As will be described later, the age at next hop can in some situation over-ride the client device age in determining how to update the routing tables.

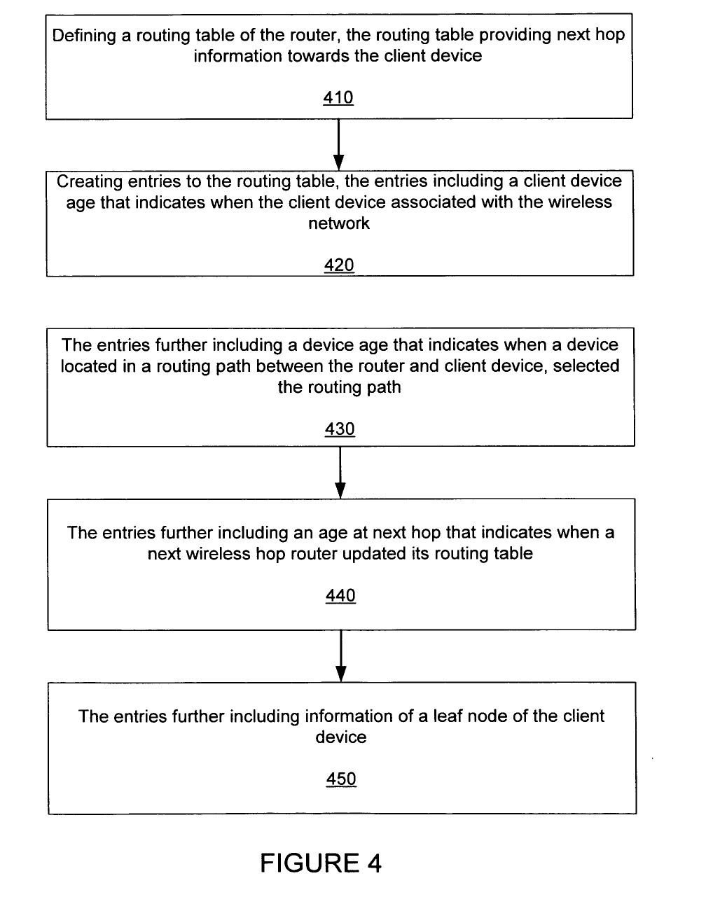

FIG. 4 is a flow chart that shows steps of maintaining a routing table of a router (access point, access node or gateway) wireless network. Generally, the entries of the routing table includes all nodes and client devices that route through the router. A first step 410 includes defining a routing table of the router, the routing table providing next hop information towards aa client device. A second step 420 includes creating entries to the routing table, wherein the entries comprise a client device age that indicates when the client device associated with the wireless network.

Additionally information can be stored within the routing tables as well. For example, a third step 430 includes creating entries by further including a router device age that indicates when a device located in a routing path between the router and client device, selected the routing path. An additional fourth step 440 includes creating entries by further including an age at next hop that indicates when a next wireless hop router updated its routing table. An additional fifth step 450 includes creating entries by including information of a leaf node of the client device.

The router can be a gateway or an access node of a wireless network or of a wireless mesh network. For a wireless mesh network, a node can be located multiple wireless hops away from router, and creating the entries further includes the device age that indicates when the node most recently selected the router as an upstream device.

If the router receives a route update having a client device age that is more recent than a previous client device age of the routing table, then the router updates the routing table with the more recent device age. If the router receives a route update having a router device age that is more recent than a previous device age of the routing table, then the router updates the routing table with the more recent client device age. That is, the router updates the routing table with a next hop device that provides the most recent client device age.

For a wireless mesh network, in which the client device is located multiple wireless hops away from router, the entries of the routing tables can additionally include an age at next hop that indicates when a next wireless hop router updated a route in its routing table. The routing tables are updated based upon the most recent client device age and most recent age at next hop. That is, if the router receives a route update having an age at next hop that is more recent than a previous age at next hop of the routing table, then the router updates routes in the routing table with a most recent age at next hop.

The entries of the routing tables of a wireless mesh network can additionally include information of a leaf node of the client device. The information of an embodiment includes the IP address of the leaf node.

Exemplary Routing Situations

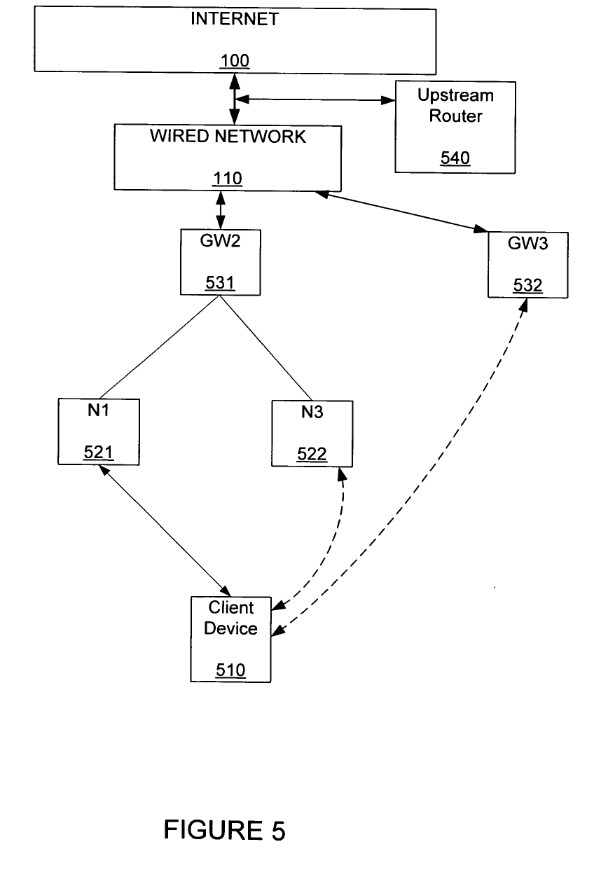

The routing table updates as have been described can be more fully understood through the illustration of client device and access node roaming situations. First consider the situation when a client device roams from a first access node to a second access node. Referring to FIG. 5, a client device 510 roams from a first access node 521 to a second access node 522, which both route through a first gateway 531. When the client device 510 associates with the second access node 522, the client device age of the client device 510 resets to zero. Therefore, the first gateway 531 properly updates its routing table to route data traffic to the client device 510 through the second access node 522, based on the aging (selects the most recent client device age) of the client device. Upon the client device 510 associating with an access node that routes through the first gateway 531, the first gateway 531 sends a GARP so that the upstream router 540 knows to route data traffic for the client device 510 through the first gateway 531.

If the client device 510 roams to a second gateway 532, the second gateway sends a GARP to the upstream router 540, and the upstream router 540 properly data traffic through the second gateway 532. However, if the client device shortly roams back to the first gateway 531, the first gateway can detect the new (more recent) client device age, and send a GARP to the upstream router so that data traffic can properly be routed back through the first gateway 531. Without the client device age, the first gateway 531 may not realize that the client device ever roamed away, and may not send a new GARP to the upstream router. Therefore, the upstream router 540 would erroneously keep routing data traffic for the client device 510 through the second gateway 532.

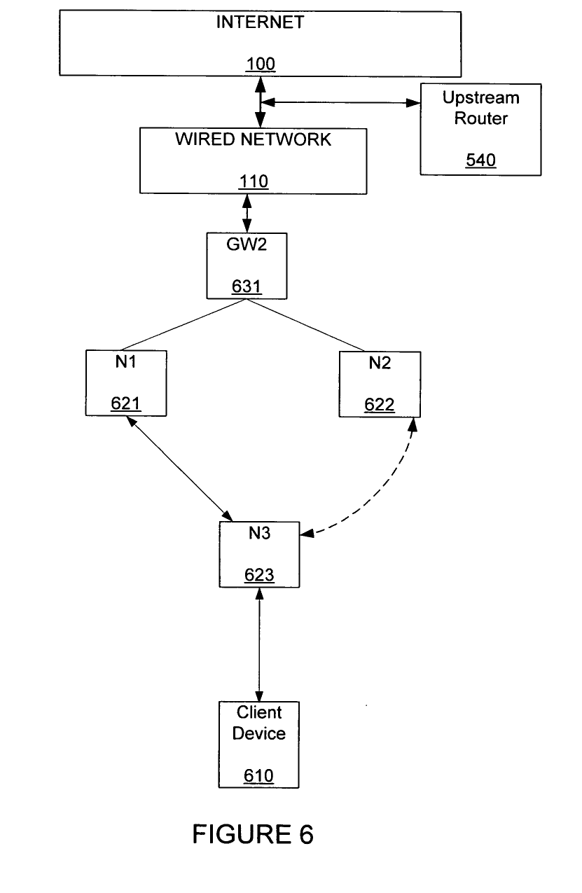

FIG. 6 shows another roaming situation in which a client device 610 is associated with a third access node 623. The third access node 623 roams from a first access node 621 to a second access node 622. Based on the client device age of the client device 610, a gateway 630 may not be able to properly determine how to update its routing table. That is, for a period of time, both the first access node 621 and the second access node 622 advertises a client device age of the client device 610 that are about the same. Therefore, in this situation, the gateway 630 can default to the age at next hop of the first access node 621 and the age at next hop of the second access node 622. The routing table of the second access node 622 is more recently updated, and therefore, the gateway properly selects the route to the client device 620 through the second access node 622.

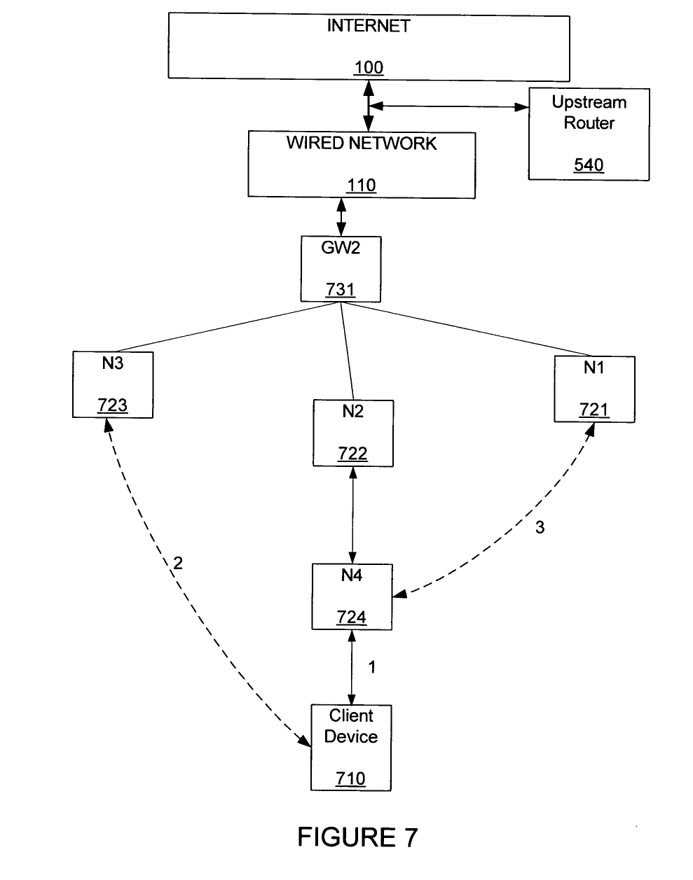

FIG. 7 shows another roaming situation in which the client device age and the age at next hop may not provide enough information for a gateway (or other device) to properly update its routing table. For this situation, information of a leaf node may provide the information required. For an embodiment, the information of the leaf node is the IP address of the leaf node. A leaf node is a node (such as an access node of a wireless mesh network) that a client device is associated with.

For the situation of FIG. 7, a client device 710 roams from a fourth access node 724 to a third access node 723 (see roam 2). Simultaneously, or shortly thereafter, the fourth access node 724 roams from a second access node 722 to a first access node 721 (see roam 3). As a result, the age at next hop of the first access node 721 is more recent than the age at next hop of the third access node. Though the client device age of the third access node 723 is more recent than the age at next hop of the first access node, a gateway 730 may select the first access node 721 as the route to the client device 710 because of the more recent age at next hop of the first access node 721. Clearly, the proper route is through the third access node 723. This situation can be resolved by noting whether the leaf node changed. Here, the leaf node changed from being the fourth access node 724, to being the third access node 723. Therefore, by detecting, for example, changes in the IP address of the leaf node, the age at next hop can be ignored, and the client device age used to determine the proper route to a client device.

The methods of controlling client mobility can be implemented as software that operates on a gateway and/or access node of a wireless network. If implemented in software, the software runs on a processor of the node (gateway or access) controlling the node according to the embodiment described.

Wireless mesh networks can be implemented that include large number of gateways and access node that each include the methods of operating a router as has been described.

The processes and methods described above can be stored in a memory of a computer system (server, gateway or access node) as a set of instructions to be executed. In addition, the instructions to perform the processes and methods described above can alternatively be stored on other forms of machine-readable media, including magnetic and optical disks. For example, the processes described can be stored on machine-readable media, such as magnetic disks or optical disks, which are accessible via a disk drive (or computer-readable medium drive). Further, instructions can be downloaded into a computing device over a data network in a form of a compiled and linked version.

Alternatively, the logic to perform the processes and methods discussed above can be implemented in additional computer and/or machine readable media, such as discrete hardware components as large-scale integrated circuits (LSI's), application-specific integrated circuits (ASIC's), firmware such as electronically erasable programmable read-only memory (EEPROM's).

Although specific embodiments of the invention have been described and illustrated, the invention is not to be limited to the specific forms or arrangements of parts so described and illustrated. The invention is limited only by the appended claims.

What is claimed:

1. A method of router within a wireless network providing mobility of a client device, comprising:
defining a routing table of the router, the routing table providing next hop information towards the client device;
creating entries to the routing table, the entries comprising a client device age that indicates when the client device associated with the wireless network.

2. The method of claim 1, wherein the router is a gateway of the wireless network.

3. The method of claim 1, wherein the router is an access node of the wireless network.

4. The method of claim 1, wherein a node of the wireless network is located multiple wireless hops away from router, and wherein creating the entries further includes the entries comprising a router device age that indicates when the node most recently selected the router as an upstream device.

5. The method of claim 4, wherein the entries of the routing table comprises all nodes and client devices that route through the router.

6. The method of claim 1, wherein if the router receives a route update having a client device age that is more recent than a previous client device age of the routing table, then the router updates the routing table with the more recent client device age.

7. The method of claim 4, wherein if the router receives a route update having a router device age that is more recent than a previous router device age of the routing table, then the router updates the routing table with the more recent router device age.

8. The method of claim 1, wherein the router updates the routing table with a next hop device that provides the most recent client device age.

9. The method of claim 4, wherein the router updates the routing table with a next hop device that provides the most recent router device age.

10. The method of claim 1, wherein the client device is located multiple wireless hops away from router, and wherein creating the entries further includes the entries comprising an age at next hop that indicates when a next wireless hop router updated a route for the client device in its routing table.

11. The method of claim 10, further comprising:
updating the entries of the routing table with next hop router routing information as determined by at least one of a most recent client device age, a most recent router device age and a most recent age at next hop.

12. The method of claim 10, wherein if the router receives a route update having an age at next hop that is more recent than a previous age at next hop of the routing table, then the router updates a route in its routing table with a most recent age at next hop.

13. The method of claim 12, wherein the router updates routes within the routing table with a next hop router that provides the most recent age at next hop.

14. The method of claim 1, wherein the client device is located multiple wireless hops away from router, and wherein creating the entries further includes the entries comprising information of a leaf node of the client device.

15. The method of claim 14, wherein the information of the leaf node comprises the IP address of the leaf node.

16. A method of a wireless mesh network providing client device roaming, the wireless mesh network comprising a plurality of access nodes, the method comprising:
each access node maintaining a routing table, the routing table comprising entries that include addresses of all nodes and client devices that route through the access node;
each access node creating entries to the routing table comprising a client device age that indicates when a client device associated with the wireless mesh network, or a router device age that indicates when a node within the route, selected the route through the access node.

17. The method of claim 16, wherein access nodes that are not gateways, advertise their routing tables to upstream devices every predetermined period of time.

18. The method of claim 16, wherein upstream devices update their routing tables based at least in part, upon the client device age of the entries of the advertised routing tables.

19. The method of claim 18, wherein updating of routing tables comprises at least one of overwriting old entries or refreshing entries.

20. The method of claim 16, wherein at least one access node of the wireless network is located multiple wireless hops away from router, and wherein creating the entries further includes the entries comprising a router device age that indicates when the at least one access node most recently selected an upstream device.

21. The method of claim 19, wherein the entries of the routing table comprises all access nodes and client devices that route through the router.

22. The method of claim 16, wherein creating entries to the routing table further comprises an age at next hop that indicates when a next wireless hop node updated an entry in its routing table.

23. The method of claim 22, wherein if a gateway or access node receives a route update having an age at next hop that is more recent than a previous age at next hop for a route in its routing table, then the gateway or access node updates a route in its routing table with the most recent age at next hop.

24. A method of maintaining routing tables of nodes of a wireless mesh network, the wireless mesh network comprising a plurality of gateways and a plurality of access node, the method comprising:
each access node selecting routing paths to a gateway;
each access node maintaining a routing table, the routing table comprising entries that include addresses of all nodes and client devices that route through the access node, the entries comprising a client age that indicates when a client device associated with the wireless mesh network, and a router device age that indicates when a node within a routing path between the access node and the client device, selected the routing path.
